(19) United States
(12) Patent Application Publication
(10) Pub. No.: US 2015/0069078 A1
(43) Pub. Date: Mar. 12, 2015

(54) Cooking Splatter Screen

(71) Applicants: Christopher Hawker, Columbus, OH (US); Joel Beebe, Columbus, OH (US); Nicholas Vallo, New Albany, OH (US)

(72) Inventors: Christopher Hawker, Columbus, OH (US); Joel Beebe, Columbus, OH (US); Nicholas Vallo, New Albany, OH (US)

(21) Appl. No.: 14/483,235

(22) Filed: Sep. 11, 2014

Related U.S. Application Data
(60) Provisional application No. 61/876,752, filed on Sep. 11, 2013.

(51) Int. Cl. A47J 37/10; B65D 43/20; B65D 43/18

(52) U.S. Cl. CPC A47J 37/101; B65D 43/18; B65D 43/20
USPC 220/810; 220/370

(57) ABSTRACT

Various embodiments of a cooking splatter screen comprising an access hatch are provided. In one embodiment, a splatter screen is provided, the splatter screen comprising: a screen portion; a handle; and an access hatch, wherein the access hatch is operatively connected to the screen portion by a joint. The splatter screen may prevent splattered cooking ingredients from exiting a pan, skillet, or pot, while allowing a chef to selectively access the interior of the pan, skillet, or pot to manipulate food therein or insert additional ingredients.

### CROSS-REFERENCE TO RELATED APPLICATIONS

This application claims priority from U.S. Provisional Patent Application No. 61/876,752, filed on Sep. 11, 2013, which is incorporated by reference herein in its entirety.

### BACKGROUND

When cooking foods, especially using a frying pan, skillet, or pot, splattering greases, oils, and sauces are often a concern. First, splattering of cooking ingredients may pose a burn risk to a chef or other individuals nearby. Second, cooking ingredients splattering from a pan, skillet, or pot may contaminate and even stain counters or walls near the cooking surface, or a chef's clothing. Third, splattering cooking ingredients may contaminate a floor near the cooking surface causing a potential slip hazard.

What is needed is a screen to prevent splattered cooking ingredients from exiting a pan, skillet, or pot, while allowing a chef to selectively access the interior of the pan, skillet, or pot to manipulate food therein or insert additional ingredients.

### SUMMARY

In one embodiment, a splatter screen is provided, the splatter screen comprising: a screen portion; a handle; and an access hatch, wherein the access hatch is operatively connected to the screen portion by a joint.

In another embodiment, a splatter screen is provided, the splatter screen comprising: a screen portion; an access hatch; and an actuation input, wherein the access hatch is operatively connected to the screen portion by a joint.

In another embodiment, a splatter screen is provided, the splatter screen comprising: a screen portion; and an access hatch, wherein the access hatch is pivotally connected to the screen portion by a joint.

### BRIEF DESCRIPTION OF THE DRAWINGS

The accompanying figures, which are incorporated in and constitute a part of the specification, illustrate various example apparatuses and are used merely to illustrate various example embodiments.

FIG. 1 illustrates a perspective view of an example arrangement of a cooking splatter screen in a first orientation.

FIG. 2 illustrates a perspective view of an example arrangement of a cooking splatter screen in a second orientation.

FIG. 3 illustrates an exploded view of an example arrangement of a cooking splatter screen.

### DETAILED DESCRIPTION

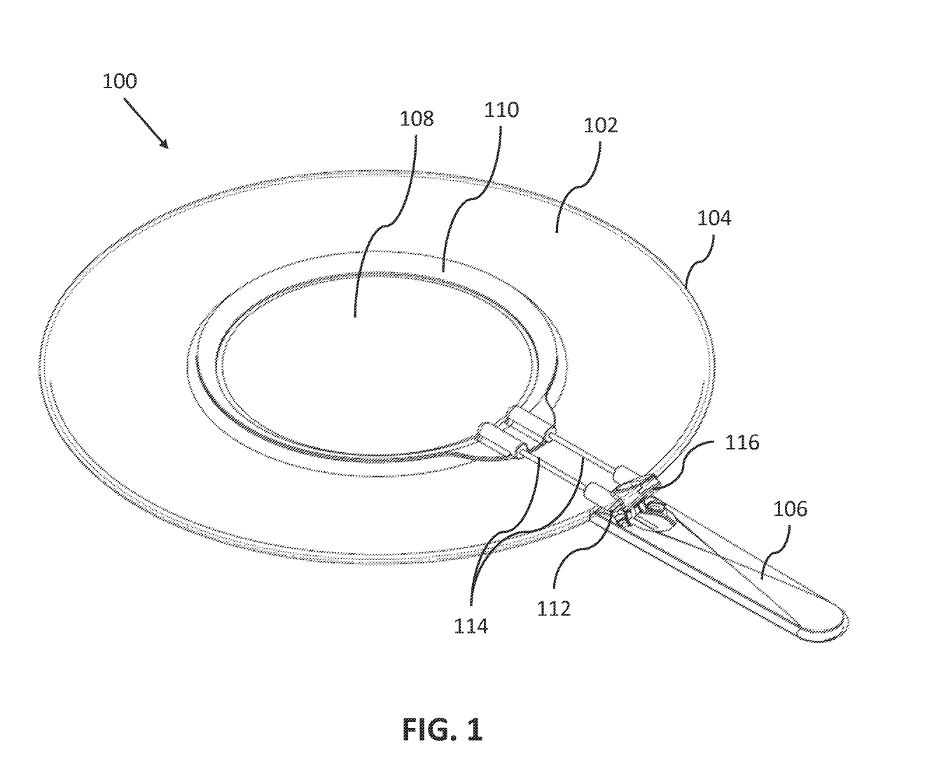

FIG. 1 illustrates a perspective view of an example arrangement of a cooking splatter screen 100 in a first orientation. Splatter screen 100 may comprise a screen portion 102, at least partially surrounded by an outer screen reinforcing rim 104. In one embodiment, splatter screen 100 comprises a handle 106. Splatter screen 100 may comprise an access hatch 108, which may be at least partially surrounded by a first outer hatch reinforcing rim 110.

Screen portion 102 may comprise any material capable of preventing passage of at least some splattered cooking ingredients, such as oil, grease, and sauces. For example, screen portion 102 may be configured to prevent passage of at least some of grease and oil splattered from bacon, grease and oil splattered from fried fish, and sauce splattered from pasta sauces.

Screen portion 102 may be comprised of any of a variety of structures, including for example a screen or a mesh. Screen portion 102 may be comprised of any of a variety of materials, including for example a metal, an alloy, a polymer, a ceramic, a glass, and a composite. In one embodiment, screen portion 102 comprises a fine mesh screen. Screen portion 102 may be configured to allow a user to at least partially see through screen portion 102 to view the cooking ingredients. In one embodiment, screen portion 102 is configured to allow heat to pass up and away from the cooking ingredients. In another embodiment, screen portion 102 is configured to allow gases such as steam or smoke to pass through screen portion 102, while preventing at least some of the splattered ingredients from passing through screen portion 102.

Screen portion 102 may comprise a substantially annular shape, wherein outer screen reinforcing rim 104 is oriented on the radially outer portion of screen portion 102. Outer screen reinforcing rim 104 may be attached to screen portion 102. In one embodiment, outer screen reinforcing rim 104 is configured to provide rigidity to screen portion 102. In another embodiment, outer screen reinforcing rim 104 is configured to engage at least a portion of a frying pan, skillet, or pot within which the cooking ingredients are being cooked. In one embodiment, outer screen reinforcing rim 104 is substantially circular. In another embodiment, outer screen reinforcing rim 104 is any of a variety of shapes.

In one embodiment, handle 106 is attached to outer screen reinforcing rim 104. In another embodiment, handle 106 is operatively connected to screen portion 102. In another embodiment, handle 106 is operatively connected to access hatch 108. In one embodiment, handle 106 is rigidly attached to at least one of outer screen reinforcing rim 104 and screen portion 102. In another embodiment, handle 106 is attached to at least one of outer screen reinforcing rim 104 and screen portion 102 such that it may be removed, folded, or rotated relative to screen portion 102.

Handle 106 may comprise a gripping portion. In one embodiment, handle 106 comprises an insulating layer insulating the exterior of handle 106 from at least one of outer screen reinforcing rim 104 and screen portion 102, so as to allow a chef to grasp handle 106 without being burned.

Access hatch 108 may be configured to prevent at least some of splattered food ingredients from passing through access hatch 108. Access hatch 108 may be comprised of any of a variety of structures, including for example a solid sheet of material, a screen, or a mesh. Access hatch 108 may be comprised of any of a variety of materials, including for example a metal, an alloy, a polymer, a ceramic, a glass, and a composite.

Access hatch 108 may be attached to at least one of screen portion 102, outer screen reinforcing rim 104, and handle 106. In one embodiment, access hatch 108 is pivotally attached to at least one of screen portion 102, outer screen reinforcing rim 104, and handle 106. In another embodiment, access hatch 108 is slidably attached to at least one of screen portion 102, outer screen reinforcing rim 104, and handle 106. In another embodiment, access hatch 108 is rotatably attached to at least one of screen portion 102, outer screen reinforcing rim 104, and handle 106. In another embodiment, access hatch 108 is removably attached to at least one of screen portion 102, outer screen reinforcing rim 104, and handle 106. In another embodiment, access hatch 108 is attached to at least one of screen portion 102, outer screen reinforcing rim 104, and handle 106 through any known means for mechanically attaching two objects.

In one embodiment, access hatch 108 comprises a first outer hatch reinforcing rim 110. In one embodiment, first outer hatch reinforcing rim 110 is attached to at least one of screen portion 102, outer screen reinforcing rim 104, and handle 106 through any of the variety of orientations by which access hatch 108 may be attached to at least one of screen portion 102, outer screen reinforcing rim 104, and handle 106. In one embodiment, first outer hatch reinforcing rim 110 may be configured to provide rigidity to access hatch 108.

As illustrated in FIG. 1, access hatch 108 may be oriented in a first position (i.e., a closed position) wherein access hatch 108 extends substantially parallel with screen portion 102. In one embodiment, screen portion 102 comprises a substantially annular shape with a center opening, and access hatch 108 may substantially close the center opening when access hatch 108 is oriented in its first position. In one embodiment, access hatch 108 in its first position, and screen portion 102, create a substantially continuous layer configured to prevent splatter of at least some ingredients during cooking. In one embodiment, access hatch 108 is configured such that it cannot extend completely through a center opening in screen portion 102, and may only lay against screen portion 102.

In one embodiment, splatter screen 100 comprises a joint 112. Joint 112 may be operatively connected to screen portion 102 and access hatch 108, such that joint 112 allows access hatch 108 to actuate relative to screen portion 102. In one embodiment, joint 112 is a pivot. In another embodiment, joint 112 is a slide. In another embodiment, joint 112 is a swivel. In one embodiment, joint 112 is attached to outer screen reinforcing rim 104. In another embodiment, joint 112 is attached to handle 106.

In one embodiment, joint 112 is directly connected to access hatch 108. In another embodiment, joint 112 is connected to access hatch 108 via at least one arm 114. At least one arm may comprise an elongated member extending from joint 112 to access hatch 108 and configured to cause access hatch 108 to lift away from screen portion 102 to permit access to a center opening in screen portion 102. At least one arm 114 may comprise a substantially rigid member comprising a rod, bar, linkage, or the like.

In one embodiment, splatter screen 100 comprises an actuation input 116. Actuation input 116 may be operatively connected to at least one of joint 112, handle 106, access hatch 108 and at least one arm 114. In one embodiment, actuation input 116 is connected to at least one arm 114 and joint 112, such that actuation of actuation input 116 causes at least one arm 114 to actuate, and as such causes access hatch 108 to move away from an opening in screen portion 102.

In one embodiment, actuation input 116 is a lever, and comprises a latch portion wherein actuation input 116 can be selectively switched in a downward position, such that access hatch 108 is selectively locked in a second position raised off screen portion 102. In another embodiment, actuation input 116 comprises a latch portion wherein actuation input 116 can be selectively switched in an upward position, such that access hatch 108 is selectively locked in a first position lowered onto screen portion 102. In one embodiment, actuation input 116 is configured to be selectively locked in both an upward position and a downward position. In one embodiment, actuation input 116 comprises a latch portion that selectively slides and engages handle 106 to keep actuation input 116 in a desired position.

In one embodiment, at least one of actuation input 116 and joint 112 comprises a biasing spring (not shown) configured to bias access hatch 108 in at least one of a first position (i.e., a closed position) and a second position (i.e., an open position).

In another embodiment, actuation input 116 is at least one or more of a lever, a button, a slide, or the like, any of which may be configured to cause actuation of access hatch 108.

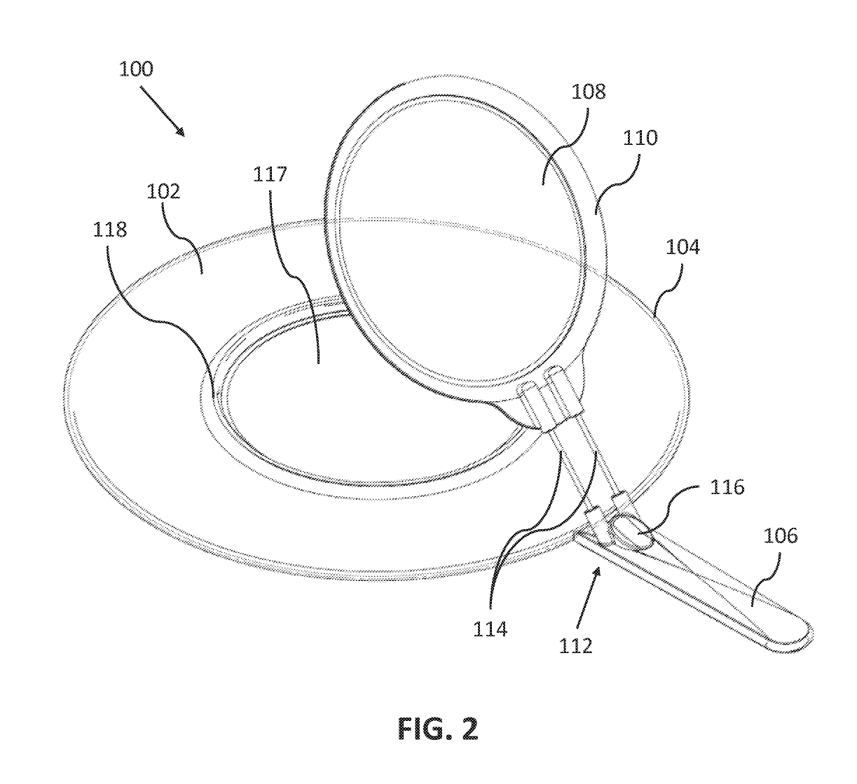

FIG. 2 illustrates a perspective view of an example arrangement of cooking splatter screen 100 in a second orientation. As illustrated in FIG. 2, access hatch 108 may be oriented in a second position (i.e., an open position) wherein access hatch 108 extends upwardly away from screen portion 102.

In one embodiment, access hatch 108 permits a chef to access and manipulate the cooking ingredients when in its second position. In another embodiment, access hatch 108 permits a chef to insert additional ingredients when in its second position.

In one embodiment, screen portion 102 comprises a center opening 117. Center opening 117 may be a substantially round opening. In one embodiment, center opening 117 comprises any of a variety of shapes. In another embodiment, center opening 117 comprises the same general shape as outer screen reinforcing rim 104. In one embodiment, center opening 117 is oriented at or near the center of screen portion 102. In another embodiment, center opening 117 is oriented at or near an edge of screen portion 102. In one embodiment, screen portion 102 comprises a plurality of openings (not shown), wherein the plurality of openings may be selectively opened all at once, or individually.

In one embodiment, joint 112 is a slide, and access hatch 108 is configured to slide away from a center opening 117 to a second position. In another embodiment, joint 112 is a swivel, and access hatch 108 is configured to rotate away from center opening 117 to a second position.

Screen portion 102 may comprise an inner screen reinforcing rim 118. In one embodiment, inner screen reinforcing rim 118 is configured to provide rigidity to screen portion 102. In another embodiment, inner screen reinforcing rim 118 is configured to contact at least a portion of access hatch 108. In another embodiment, inner screen reinforcing rim 118 is configured to contact outer hatch reinforcing rim 110. In another embodiment, inner screen reinforcing rim 118 is configured to substantially seal against at least a portion of access hatch 108, including for example outer hatch reinforcing rim 110.

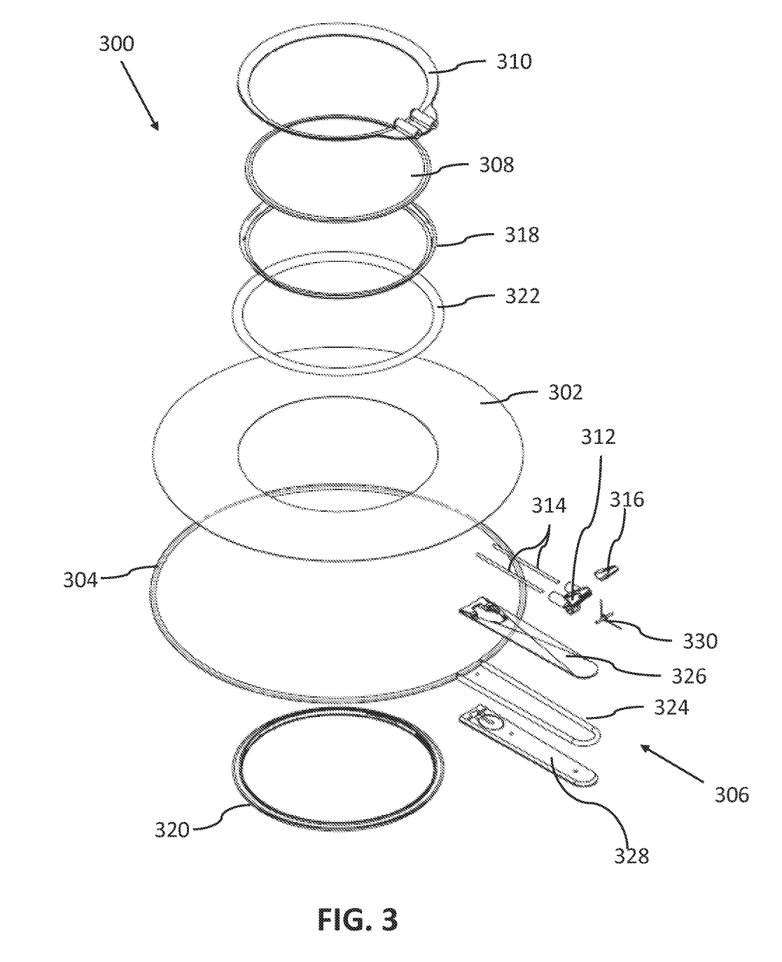

FIG. 3 illustrates an exploded view of an example arrangement of a cooking splatter screen 300. Splatter screen 300 may comprise a screen portion 302, an outer screen reinforcing rim 304, a handle 306, an access hatch 308, an outer hatch reinforcing rim 310, joint 312, at least one arm 314, an actuation input 316, an upper inner screen reinforcing rim 318, a lower inner screen reinforcing rim 320, an inner screen gasket 322, a handle reinforcement 324, an upper handle grip portion 326, a lower handle grip portion 328, and a biasing spring 330.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. A splatter screen, comprising:
a screen portion;
a handle; and
an access hatch,
wherein the access hatch is operatively connected to the screen portion by a joint.

2. The splatter screen of claim 1, wherein the screen portion comprises a fine mesh screen.

3. The splatter screen of claim 1, wherein the access hatch comprises at least one of: a solid sheet of material, a screen, and a mesh.

4. The splatter screen of claim 1, wherein the joint is a pivot, and wherein the access hatch is pivotally connected to the screen portion.

5. The splatter screen of claim 1, wherein the joint is at least one of: a pivot, a slide, and a swivel.

6. The splatter screen of claim 1, further comprising at least one arm operatively connecting the joint to the access hatch.

7. The splatter screen of claim 1, further comprising an actuation input operatively connected to the access hatch.

8. A splatter screen, comprising:
a screen portion;
an access hatch; and
an actuation input,
wherein the access hatch is operatively connected to the screen portion by a joint.

9. The splatter screen of claim 8, wherein the screen portion comprises a fine mesh screen.

10. The splatter screen of claim 8, wherein the access hatch comprises at least one of: a solid sheet of material, a screen, and a mesh.

11. The splatter screen of claim 8, wherein the joint is a pivot, and wherein the access hatch is pivotally connected to the screen portion.

12. The splatter screen of claim 8, wherein the joint is at least one of: a pivot, a slide, and a swivel.

13. The splatter screen of claim 8, further comprising at least one arm operatively connecting the joint to the access hatch.

14. The splatter screen of claim 13, wherein the actuation input is operatively connected to the at least one arm.

15. A splatter screen, comprising:
a screen portion; and
an access hatch,
wherein the access hatch is pivotally connected to the screen portion by a joint.

16. The splatter screen of claim 15, wherein the screen portion comprises a fine mesh screen.

17. The splatter screen of claim 15, wherein the access hatch comprises at least one of: a solid sheet of material, a screen, and a mesh.

18. The splatter screen of claim 15, further comprising at least one arm operatively connecting the joint to the access hatch.

19. The splatter screen of claim 15, further comprising an actuation input operatively connected to the access hatch.

20. The splatter screen of claim 15, further comprising a handle.
